(19) United States
(12) Patent Application Publication
(10) Pub. No.: US 2018/0032317 A1
(43) Pub. Date: Feb. 1, 2018

(54) DEFINING A DATA INPUT USER INTERFACE

(71) Applicant: Proscape Technologies, Inc., Horsham, PA (US)

(72) Inventors: Timothy Healy, Horsham, PA (US); Derek Pollock, Horsham, PA (US); Sanjeev Surati, Horsham, PA (US); Michael McCloskey, Horsham, PA (US)

(21) Appl. No.: 15/710,010

(22) Filed: Sep. 20, 2017

Related U.S. Application Data
(63) Continuation-in-part of application No. 15/252,075, filed on Aug. 30, 2016, now Pat. No. 9,785,326.
Application No. 15/252,075 is a continuation-in-part of application No. 12/196,881, filed on Aug. 22, 2008, now Pat. No. 9,442,703.
(60) Provisional application No. 60/957,354, filed on Aug. 22, 2007.

(51) Int. Cl. G06F 9/44; G06F 3/0484; H04N 21/472; G06T 11/60

(52) U.S. Cl. CPC G06F 8/38; G06T 11/60; G06F 3/04842; G06F 3/04845; H04N 21/47217

(57) ABSTRACT

The disclosure includes methods and systems implemented at least in part by a machine for defining and generating graphics for one or more interactive elements to be used in an interactive user interface. Methods can include inputting into a graphical user interface a first full screen graphic and defining a first data area that represents a first interactive element within the first full screen graphic. Methods can also include defining an input area that represents an input interactive element within the first full screen graphic and defining a first event to occur when a user selects the input interactive element. In some embodiments, the first event corresponds to an event for the first interactive element.

### CROSS-REFERENCE TO RELATED APPLICATIONS

This application claims the benefit of and is a continuation-in-part of U.S. Nonprovisional patent application Ser. No. 15/252,075; filed Aug. 30, 2016; and entitled DEFINING AND TRACKING AN INTERACTIVE USER INTERFACE. The entire contents of patent application Ser. No. 15/252,075 are incorporated by reference herein. U.S. Nonprovisional patent application Ser. No. 15/252,075 claims the benefit of and is a continuation-in-part of U.S. Nonprovisional patent application Ser. No. 12/196,881 (now U.S. Pat. No. 9,442,703); filed Aug. 22, 2008; and entitled DEFINING AN INTERACTIVE USER INTERFACE. The entire contents of patent application Ser. No. 12/196,881 are incorporated by reference herein. U.S. Nonprovisional patent application Ser. No. 12/196,881 claims the benefit and priority of U.S. Provisional Patent Application No. 60/957,354; filed Aug. 22, 2007; and entitled DEFINING AN INTERACTIVE USER INTERFACE. The entire contents of Patent Application No. 60/957,354 are incorporated by reference herein.

### BACKGROUND

### Field

The invention relates generally to a method and system of defining and tracking an interactive user interface.

### Description of Related Art

Interactive applications generally have a user interface comprised of interactive elements, such as buttons. The interactive elements often have multiple states that occur in response to various user actions. The interactive applications are generally constructed using a cut and paste technique.

Interactive applications are generally constructed by a method known as “cutting and placing.” First, graphics creation and editing software, such as Adobe Photoshop®, is used to author the overall appearance and layout of the interface. Graphics for each state of each individual interactive element are created, usually by defining and cutting the element from an overall layout, and then saving as an individual file. For a two state element, such as a button, it is typically displayed in a normal state, but then displayed in a rollover state in response to mouse location. The author manually creates and saves at least one image for the rollover state of the button and a background image containing the normal image of the button at the correct geometric position. This method requires the cutting and placing of a large number of graphic files when the interactive interface is complex, such as when multiple interactive elements are desired. In certain instances, for an interface containing multiple elements having multiple states, the number of images “I” requiring creation would be at least I=(E×(S−1))+1, where “E” is the number of interactive elements in the interface and “S” is the number of states (assuming all elements have the same number of states). Other instances require that a graphic be created for each state of each of the individual interactive elements. In these other instances, the number of graphics an author must create and manage increases to I=(E×S)+1.

The second step of the construction process requires placement of the created images at their proper geometric position within the interface. To create the final interface, the author would usually need a second software application, such as Adobe® Flash®. Using these tools, the author can place an individual image for each state of each interactive element against a background graphic, trying to place the respective state image of the interactive element back in the exact, original location of the element within the overall layout. When individual graphic files are created and saved for each element at the cutting stage, the files only retain their size information, but not their positional information in relation to the overall interface from which the element was cut. Because of the lack of inherent positional information in the files, the author must manually line up each of the completed, individual pieces of graphics to achieve the intended look, oftentimes through multiple rounds of painstaking trial and error.

Finally, the graphic for each state of each interactive element must be assembled, and functionality defined, so that a pre-determined function is assigned to each state of each element in response to user input. Depending on the output platform, the defining can occur during reassembly of the element layers in the overall interface, or as a separate step. The entire process can be time-consuming and prone to error. If the author later decides to change an image for one or more states of one or more elements, or decides to add a state, the entire process of “cutting and placing,” and defining and reassembly of the respective elements must be performed again. Accordingly, there is a need for systems and methods to remedy the deficiencies as described above.

### SUMMARY

The present disclosure includes systems and methods implemented at least in part by a machine for defining and generating graphics for one or more interactive elements to be used in an interactive user interface. Methods can include inputting into a graphical user interface a first full screen graphic and defining a first data area that represents a first interactive element within the first full screen graphic. Methods can also include defining an input area that represents an input interactive element within the first full screen graphic and defining a first event to occur when a user selects the input interactive element. The first event can correspond to an event for the first interactive element.

In some embodiments, the method further includes defining the first event to occur when the user selects the first interactive element. The first event can comprise at least one of navigating to a second full screen graphic, calculating a value, transmitting data to a remote computer, storing data, and capturing a picture.

The first interactive element can include a first state and a second state. The first state can define a first image and the second state can define a second image that is different from the first image. In some embodiments, the first image comprises a non-highlighted image and the second image comprises a highlighted image.

Even still, in some embodiments, the method includes defining a second data area that represents a second interactive element within the first full screen graphic and defining a second event to occur when the user selects the input interactive element. The second event can correspond to an event for the second interactive element. Methods can include defining the second event to occur when the user selects the second interactive element. Additionally, the second event can be different from the first event.

In some embodiments, the method includes defining a video area that represents a video within the first full screen graphic. Methods can also include defining a video control area that represents a video control interactive element of the video. Additionally, methods can include defining a video event to occur when the user selects at least a portion of the video control interactive element. The video event can include at least one of playing, pausing, and entering a full screen mode of the video.

Additionally, in some embodiments, the method includes defining a first graphic area within the first full screen graphic and inputting a first graphic into the first graphic area. The first graphic can be smaller than the first full screen graphic. In some embodiments, the method is implemented at least in part by one of a smartphone, a tablet, a computer, and a remote server.

The disclosure also includes a system for defining and generating graphics for one or more interactive elements to be used in an interactive user interface. Systems can include a processor system and memory coupled to the processor system. The memory can include executable instructions that, when executed by the processor system, cause the processor system to effectuate operations comprising inputting into a graphical user interface a first full screen graphic and defining a first data area that represents a first interactive element within the first full screen graphic. The operations can also include defining an input area that represents an input interactive element and defining a first event to occur when a user selects the input interactive element. The first event may correspond to an event for the first interactive element.

The executable instructions can further cause the processor system to effectuate operations comprising defining the first event to occur when the user selects the first interactive element. The first event can include at least one of navigating to a second full screen graphic, calculating a value, transmitting data to a remote computer, storing data, and capturing a picture.

In some embodiments, the first interactive element can include a first state defining a first image and a second state defining a second image. Additionally, the executable instructions can further cause the processor system to effectuate operations comprising defining a second data area that represents a second interactive element within the first full screen graphic and defining a second event to occur when the user selects the input interactive element. The second event can correspond to an event for the second interactive element. The operations can also include defining the second event to occur when the user selects the second interactive element.

Even still, in some embodiments, the executable instructions further cause the processor system to effectuate operations comprising defining a video area that represents a video, defining a video control area that represents a video within the first full screen graphic, and defining a video event to occur when the user selects at least a portion of the video control interactive element. The video event may comprise at least one of playing, pausing, and entering a full screen mode of the video.

Additionally, the executable instructions can further cause the processor system to effectuate operations comprising defining a first graphic area of the first full screen graphic and inputting a first graphic into the first graphic area. The first graphic can be smaller than the first full screen graphic.

### BRIEF DESCRIPTION OF THE DRAWINGS

These and other features, aspects, and advantages are described below with reference to the drawings, which are intended to illustrate, but not to limit, the invention. In the drawings, like reference characters denote corresponding features consistently throughout similar embodiments. The above and other features of the present invention will become more apparent by describing in detail exemplary embodiments thereof with reference to the accompanying drawings, in which:

FIG. 1 illustrates a computing system in which the present invention can be implemented, according to some embodiments;

FIG. 2 illustrates an example of components of the present invention in system memory, according to some embodiments;

FIG. 3 illustrates an example of components of the present invention stored on a non-volatile computer readable media, according to some embodiments;

FIG. 4 illustrates a flowchart of method steps, according to some embodiments;

FIGS. 5A and 5B illustrate an example of “cutting and placing” methods, according to some embodiments;

FIGS. 6A and 6B illustrate two full screen graphics used as input to generate the same interactive elements as shown in FIGS. 5A and 5B, according to some embodiments;

FIG. 7 illustrates a graphical interface of the invention in Design Mode, according to some embodiments;

FIGS. 8A and 8B illustrate graphical interfaces of the invention in Preview Mode, according to some embodiments;

FIGS. 9, 10, and 11 illustrate flowcharts of various method steps, according to some embodiments;

FIGS. 12a and 12b illustrate graphical interfaces, according to some embodiments; and

FIG. 13 illustrates a flowchart of method steps, according to some embodiments.

### DETAILED DESCRIPTION

Although certain embodiments and examples are disclosed below, inventive subject matter extends beyond the specifically disclosed embodiments to other alternative embodiments and/or uses, and to modifications and equivalents thereof. Thus, the scope of the claims appended hereto is not limited by any of the particular embodiments described below. For example, in any method or process disclosed herein, the acts or operations of the method or process may be performed in any suitable sequence and are not necessarily limited to any particular disclosed sequence. Various operations may be described as multiple discrete operations in turn, in a manner that may be helpful in understanding certain embodiments; however, the order of description should not be construed to imply that these operations are order dependent. Additionally, the structures, systems, and/or devices described herein may be embodied as integrated components or as separate components.

For purposes of comparing various embodiments, certain aspects and advantages of these embodiments are described. Not necessarily all such aspects or advantages are achieved by any particular embodiment. Thus, for example, various embodiments may be carried out in a manner that achieves or optimizes one advantage or group of advantages as taught herein without necessarily achieving other aspects or advantages as may also be taught or suggested herein.

The following discussion is intended to provide a brief general description of a suitable computing environment in which an example embodiment of the invention may be implemented. It should be understood, however, that handheld, portable, remote, and other computing devices of all kinds are contemplated for use in connection with the present invention. While a general-purpose computer is described below, this is but one example. The present invention also may be operable on any computing thin client having network server interoperability and interaction. Thus, an example embodiment of the invention may be implemented in an environment of networked hosted services in which very little or minimal client resources are implicated, e.g., a networked environment in which the client device serves merely as a browser or interface to the Internet.

Although not required, the invention can be implemented via an application programming interface (API), for use by a developer or tester, and/or included within the network browsing software, which will be described in the general context of computer-executable instructions, such as program modules, being executed by one or more computers (e.g., client workstations, servers, or other devices). Generally, program modules can include routines, programs, objects, components, data structures and the like that perform particular tasks or implement particular abstract data types. Typically, the functionality of the program modules may be combined or distributed as desired in various embodiments. Moreover, those skilled in the art will appreciate that the invention may be practiced with other computer system configurations. Other well known computing systems, environments, and/or configurations that may be suitable for use with the invention include, but are not limited to, personal computers (PCs), server computers, remote computing devices, handheld devices, laptop devices, multi-processor systems, microprocessor based systems, programmable consumer electronics, network PCs, minicomputers, mainframe computers, and the like. An embodiment of the invention may also be practiced in distributed computing environments where tasks are performed by remote processing devices that are linked through a communications network or other data transmission medium. In a distributed computing environment, program modules may be located in both local and remote computer storage media including memory storage devices.

### Computing Systems

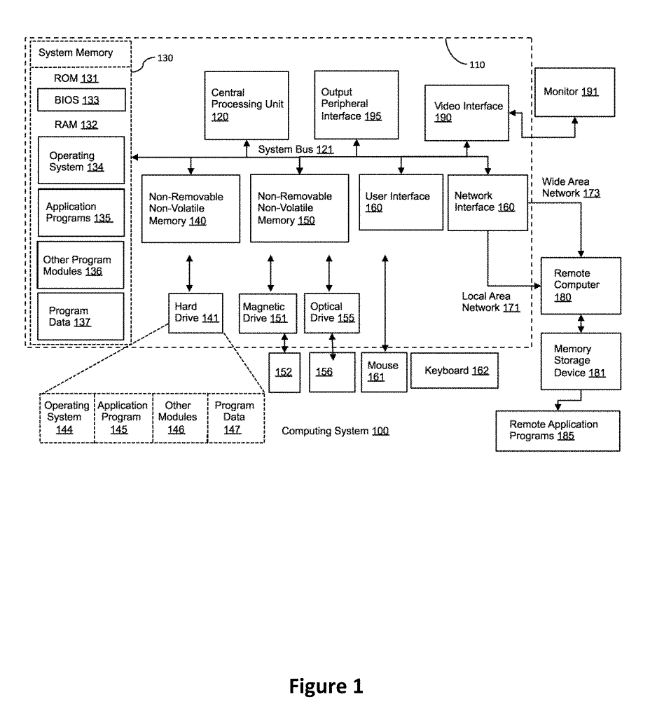

FIG. 1 illustrates a computing system environment 100 in which the invention may be implemented; although as made clear above, the computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

With continued reference to FIG. 1, an example system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures m ay include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus (also known as Mezzanine bus), and PCI-Express bus.

Computer 110 typically includes a variety of computer readable media, which can be any available media that can be accessed by computer 110, including volatile and nonvolatile, removable and non-removable media. By way of example, and not limitation, computer readable media may comprise computer storage media and communication media. Computer storage media includes volatile and nonvolatile, removable and non- removable media implemented in any method or technology for storage of information such as computer readable instructions, data structures, program modules or other data. Computer storage media includes, but is not limited to, random access memory (RAM), read-only memory (ROM), Electrically-Erasable Programmable Read-Only Memory (EEPROM), flash memory or other memory technology, compact disc read-only memory (CDROM), digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared, and other wireless media. Combinations of any of the above should also be included within the scope of computer readable media.

The system memory 130 may also include computer storage media in the form of volatile and/or nonvolatile memory such as ROM 131 and RAM 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137. RAM 132 may contain other data and/or program modules.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156, such as a CD ROM or other optical media. Other removable/non-removable, volatile/nonvolatile computer storage media that can be used in the example operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1 provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus 121, but may be connected by other interface and bus structures, such as a parallel port, game port or a universal serial bus (USB).

A monitor 191 or other type of display device can also connected to the system bus 121 via an interface, such as a video interface 190. In addition to monitor 191, computers may also include other peripheral output devices such as speaker(s) and printer(s) (not shown), which may be connected through an output peripheral interface 195.

The computer 110 may operate in a networked environment using logical connections to one or more remote computers, such as a remote computer 180. The remote computer 180 may include personal computers (e.g. laptops), servers, routers, network PCs, mobile devices, smartphones, tablets, smart watches, wearable devices, cellular phones, wireless devices, peer devices or other common network nodes, and the like. Additionally, the remote computer 180 typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 can be connected to the LAN 171 through a network interface or adapter 170. When used in a WAN networking environment, the computer 110 typically includes means for establishing communications over the WAN 173, such as the Internet. In a networked environment, program modules depicted relative to the computer 110, or portions thereof, may be stored in the remote memory storage device. By way of example, and not limitation, FIG. 1 illustrates remote application programs 185 as residing on memory device 181. Remote application programs 185 include, but not limited to, web server applications such as Microsoft® Internet Information Services® (IIS) and Apache HTTP Server, which can provide content residing on the remote storage device 181 or other accessible storage device to the World Wide Web. It will be appreciated that the network connections shown are exemplary and other means of establishing a communications link between the computers may be used.

One of ordinary skill in the art can appreciate that a computer 110 or other client devices can be deployed as part of a computer network. In this regard, the present invention pertains to any computer system having any number of memory or storage units, and any number of applications and processes occurring across any number of storage units or volumes. An embodiment of the present invention may apply to an environment with server computers and client computers deployed in a network environment, having remote or local storage. The present invention may also apply to a standalone computing device, having programming language functionality, interpretation and execution capabilities.

### Carving Station Embodiments

The present invention, also known as Carving Station, introduces a novel approach to the creation of interactive applications by uniquely organizing information and automating much of the process of defining an interactive user interface. Carving Station allows the automation process to be customized for any platform. In some embodiments, Carving Station provides a Design mode for composition of the interactive interface, and a Preview mode for visualization and validation of the created interactive interface.

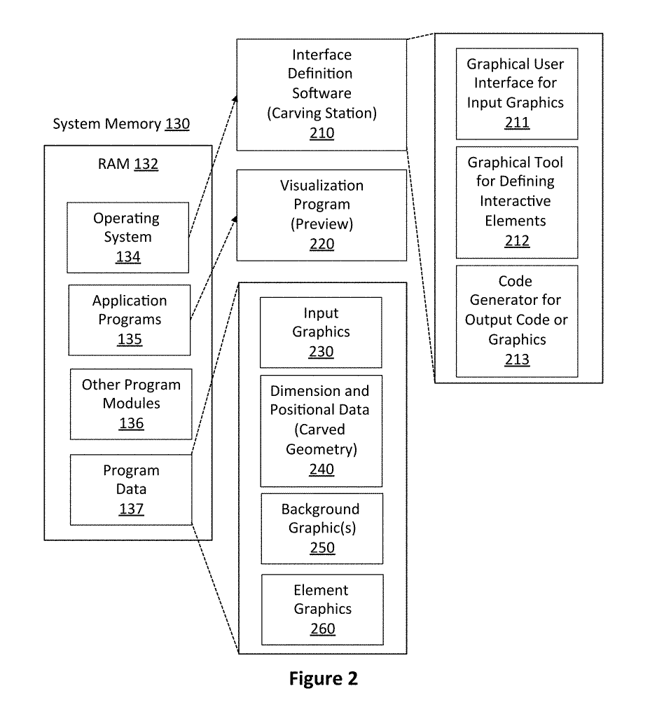

FIG. 2 illustrates components of Carving Station in system memory 130. According to such embodiments, Carving Station 210 resides in the system memory 130 as one of the application programs 135. A graphical user interface component 211 can be provided for inputting graphics, and a graphical tool 212 for the definition of interactive elements. Finally, a code generator 213 is provided for the generation of output codes and graphics. Other program modules 136, such as a visualization program 220, are provided for the visualization and validation of the composition, if needed. Program data 137 includes, but is not limited to, input graphics 230, dimensional and positional data of the defined interactive elements (Carved Geometry) 240, background graphic(s) 250, and output element graphics 260, if required by the selected output platform.

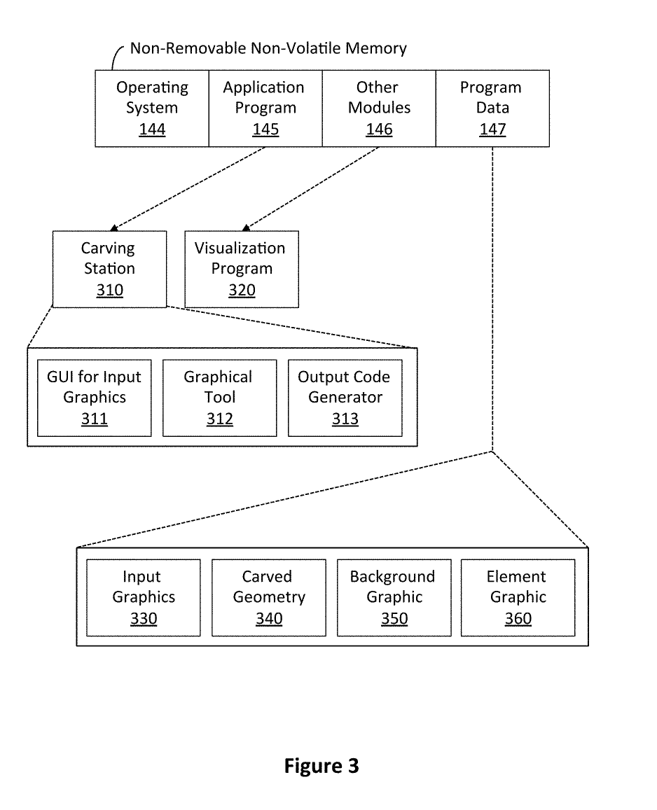

According to FIG. 3 some embodiments of the components of Carving Station, are stored on a non-volatile computer readable media device 141, such as a hard drive. The Carving Station program 310, and its components (graphical user interface for input graphics 311, graphical tool for defining interactive elements 312, and code generator for output code or graphics 313) are stored as an application program 145 on the computer readable media 141 and can be read into system memory 130 at run time. The computer readable media may also contain other program modules 146, such as a copy of the visualization program 320 for the visualization and validation of the composition. Program data 147, which can include, but is not limited to, input graphics 330, dimensional and positional data for the defined elements (Carved Geometry) 340, background graphic 350, and graphics for the interactive elements 360 if required by the output platform.

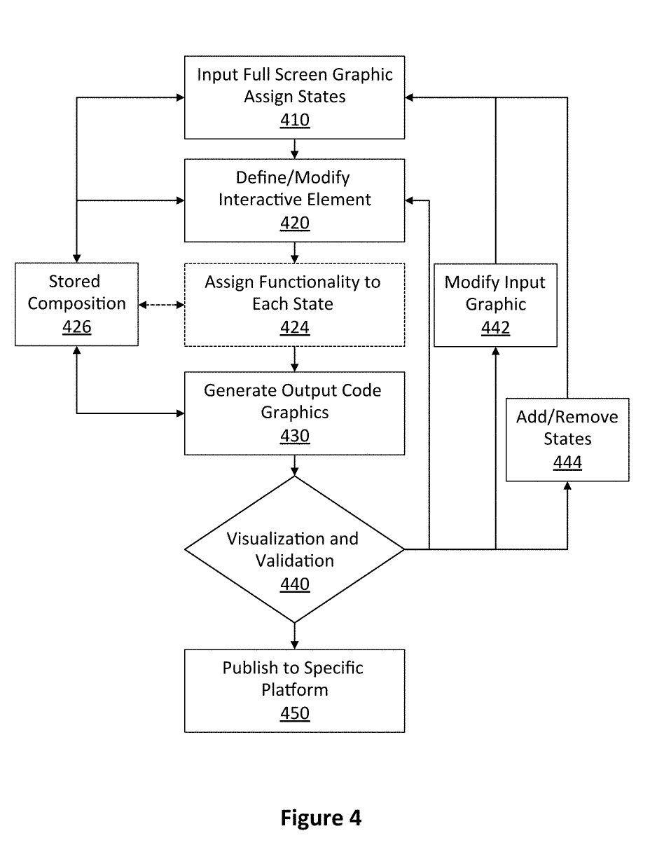

FIG. 4 illustrates a flowchart of various method steps of the present invention. In a platform generic embodiment of the invention, a computerized method for defining an interactive user interface can include inputting one full screen graphics of an interactive user interface for each state of the interactive user interface 410, defining and/or modifying an area within the interactive user interface for each of the one or more interactive elements 420, and automatically generating platform specific computer readable code enabling a graphic display of each state of each interactive element 430. Further, editing an interactive user interface already defined involves inputting one full screen graphics of the interactive user interface for each state of the defined interactive user interface to be revised 442 or added 444, defining and/or modifying an area within the interactive user interface for each interactive element to be added or revised 420; and automatically generating computer readable code enabling a graphic display of each state of each interactive element 430.

More specifically, the author first can decide on a layout of the interactive user interface, including the number of states for the interactive elements. Instead of inputting an individual graphic for each state of each element, as customarily done, the author can input one full screen graphics for each state 410, where the one full screen graphics contains all of the interactive elements displayed in the respective state. For example, for a rollover state, the author inputs only one full screen graphics, where the one full screen graphics shows each interactive element in its rollover state. A full screen graphics, as used herein, can refer to a graphic that occupies the entire intended display area of the interactive interface, or to a graphic of a portion of the interactive interface within which the interactive elements would reside.

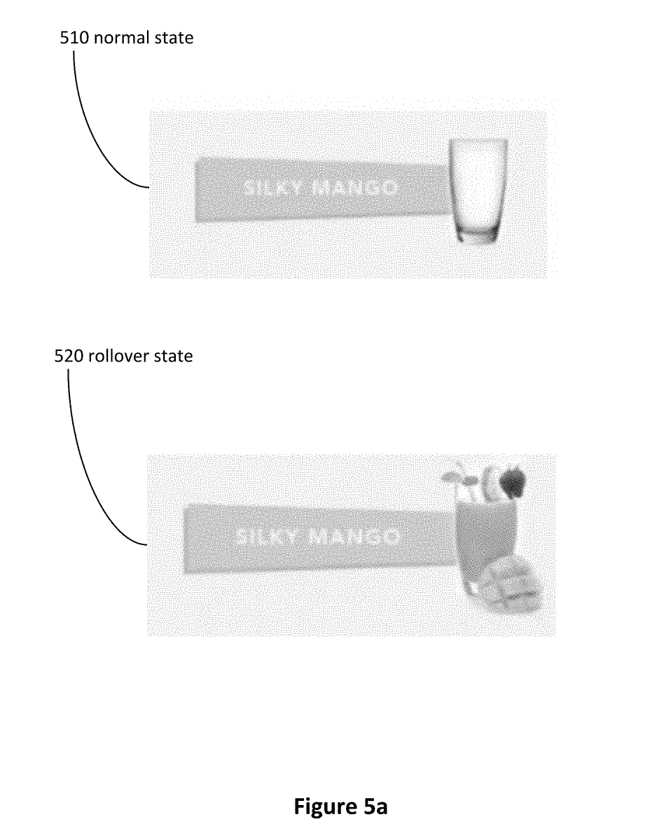

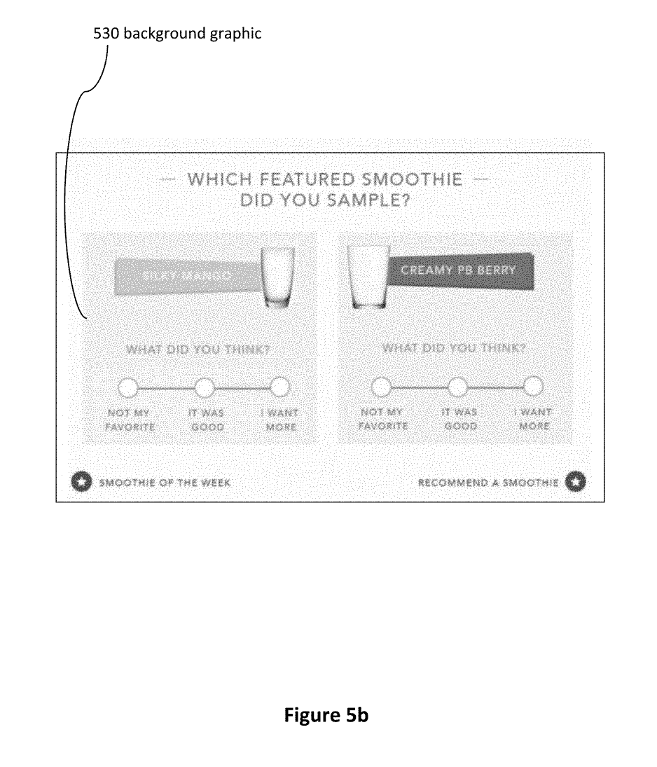

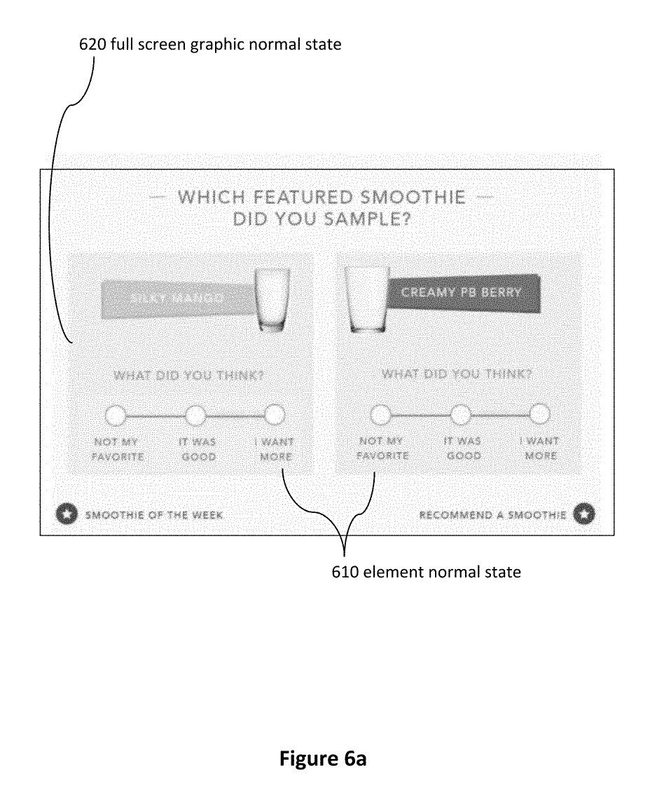

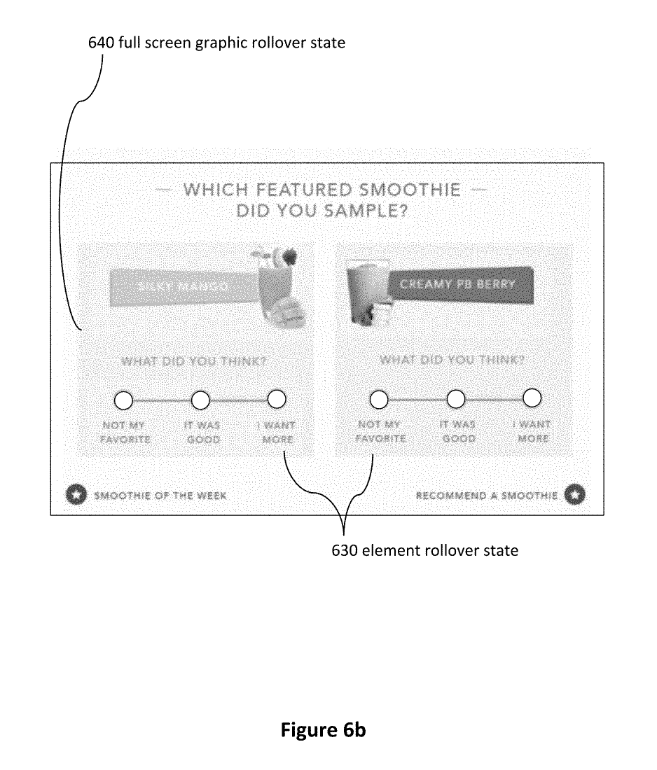

Accordingly, the number of images the author must create is equal to the number of states, I=E. Therefore, the present invention greatly reduces the number of individual data points, such as graphics and positional information, the author must supply and manage. FIGS. 5A and 5B illustrate an example of the prior art “cutting and placing” method. For an interface having six two-state buttons, a total of 13 individual graphics must be created (one graphic for each of six buttons for the normal state 510 (FIG. 5A), one graphic for each of six buttons for the rollover state 520 (FIG. 1A), and one background graphic 530 (FIG. 5B). FIGS. 6A and 6B illustrate two images input by the author in the present invention to generate the same six button two-state interface shown in FIGS. 5A and 5B. Using Carving Station, the author inputs only one full screen graphics for the normal state 620, which shows all elements in their normal state 610 (FIG. 6A), and one full screen graphics for the rollover state 640, which shows all elements in their rollover state 630 (FIG. 6B).

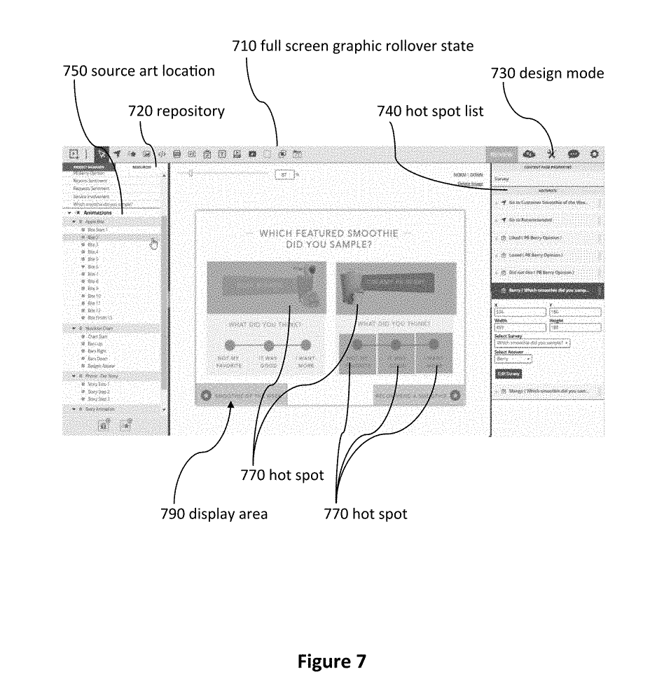

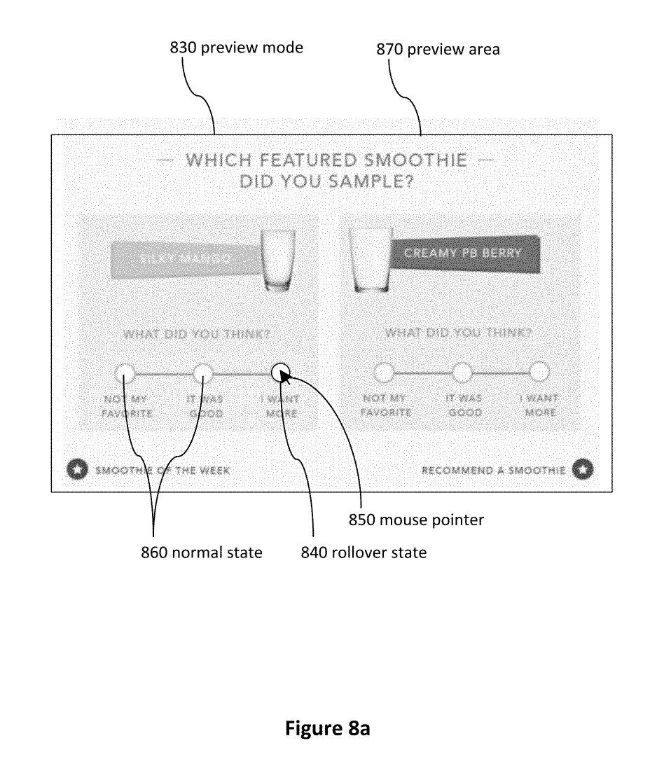

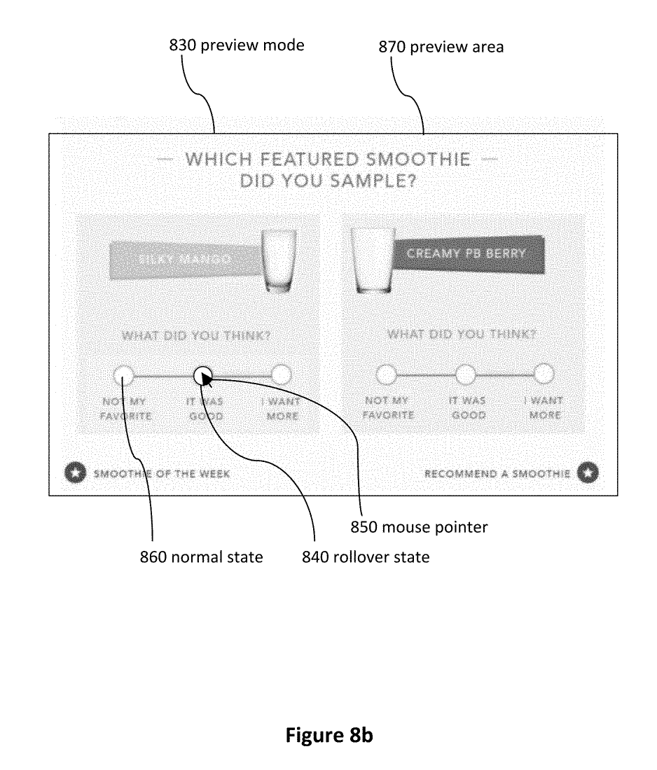

Referring now to FIG. 7, Carving Station provides a graphical user interface for the input graphics 311 in a Design mode 730. The author inputs each created full screen graphics into Carving Station, and assigns the graphic to its corresponding state 410. FIG. 7 illustrates a screen shot of the graphical user interface of embodiment 710 of the present invention in the design mode 730. In the FIG. 7 embodiment, Carving Station 710 is a stand-alone Windows application, although the present invention can be adapted for other applications, or as a component of a larger software package, such as Adobe Photoshop®, Flash®, or Microsoft® Visual Studio®. In some embodiments, Carving Station 710 is implemented through a .NET application running on a server in combination with a connected browser client application implemented in Javascript using REST service calls. As shown in FIG. 7, the interface can provide the author an option to select between the Design mode 730 and a Preview Mode 830 (FIGS. 8A and 8B). The author can also designate a location for Source Art 750, where the full screen graphics (input graphics 330) can be located. A file name for each full screen graphics can be entered into the corresponding space for each respective layer (each included state representing a layer). The full screen graphics are displayed as layers in a display area 790. In one embodiment of the invention, Carving Station 710 provides four state layers (Normal, Mouse Over (i.e., Rollover), Pressed, and Disabled). In the example illustrated in FIG. 7, only two states are used (Normal and Mouse Over), with the unused states left blank. The author can also designate a location for the collection of the output files, such as: store to Repository 720; File System; Oracle® Database; SQL Server database; and Microsoft® Content Manager Server. The output files can be made compatible with various formats, such as: Adobe® Flash® Movie; PowerPoint® file; HTML Page; and Microsoft® Sharepoint® server; etc.

As a final author step in the design process of the present invention, the author uses tools provided by Carving Station 212 to graphically identify areas on the full screen graphics corresponding to the desired individual interactive elements 420. In the example of FIG. 7, the individual elements, Hot Spots 770, are defined as rectangles. The areas selected (Hot Spots 770) to define the interactive elements are highlighted in a different color. Each Hot Spot is assigned a name, and is displayed in a list 740. All of the interactive elements for all of the states (or layers) are defined at the same time. The size and positional information of each interactive element in relation to the full screen graphics (Carved geometry) 240, is inherent to the definition of the geometrical area that represents each interactive element, and is recorded and saved when defined by the author. Therefore, the customary need to retain positional information externally is eliminated, along with the requirement of placing (or replacing) the elements manually through trial and error.

At any time during the interactive interface defining process, the author can define and save an entire composition 426, including all of the graphics and all of the positional and size information of the interactive elements, to a computer readable media 147. Functionality for each state of each of the interactive element can be assigned during element definition, or as a separate step at a later time 424. If the author later desires to change the look of a state, all the author needs to do is input a full screen graphics incorporating the desired change 442, replacing the original graphic associated with the respective state. The present invention then detects that a source graphic has changed and automatically updates the composition. The author could then store the updated composition. If an author desires to add states to an already defined interface, the author merely inputs one full screen graphics for each state the author would like to add 444, and associates the respective full screen graphics with the proper state. If the author desires to add an interactive element, the author merely identifies an area on the full screen graphics for the interactive element to be added 420. A name is assigned to the newly added element 740, and the size and positional information of the added interactive element is automatically recorded and saved 426. Accordingly, there is no need to supply, manage and place numerous graphics, or to define and reassemble every element layer in the interactive user interface. Since the design process of the present invention is platform independent, the author needs focus only on aesthetics of the interface, with no concern to platform specific coding.

Preview mode 830 (FIGS. 8A and 8B) enables the author to visualize and validate the interactive interface designed 440. In a preferred embodiment, a specific platform is selected by the author at the beginning of the design process. When the Preview mode 830 is selected, the Carving Station, using the dimension and positional information (Carved geometry) 240 and supplied source graphics 230, automatically generates graphics and code specific for the selected platform 430. The interactive interface designed by the author is previewed as native code for the platform of intended interactive interface publication. For example, if the author chooses to publish the final interactive interface as a regular web page, Carving Station would automatically generate graphics for the individual interactive elements. Because the composition retains both positional and size information of the element graphics, Carving Station can then automatically generate an HTML file that references graphics containing the correct layout of the respective interactive elements. There is no need for the author to input or adjust the positional information manually. In one embodiment, an instance of the appropriate viewer for the platform selected is invoked within the Carving Station Preview window. In the example of an HTML webpage, the Internet Explorer® Web Browser Control is used. Carving Station can easily output interactive interfaces conforming to other platforms, such as Microsoft®.NET, PowerPoint®, Adobe® Flash®, Android®, IOS®, and Windows® UWP without any alteration to the design process. When the author is satisfied with the interactive interface designed, the author can instruct Carving Station to “publish” the interactive interface 450. All corresponding graphics and codes are automatically generated by Carving Station and stored in the author defined output destination, such as a repository directory 720.

FIGS. 8A and 8B illustrate a screen shot of Carving Station 710 in the Preview mode 830. In the FIGS. 8A and 8B illustration, the interactive interface created and shown in FIG. 7 is displayed in the preview area 870. Two views of the Preview mode 830 (FIG. 8A and 8B, respectively) are shown to demonstrate the interactivity defined by the author. In FIG. 8A, the mouse pointer 850 is placed on top of the first element, and the first button is displayed in the rollover state 840, while the rest of the elements remain displayed in the normal state 860. In FIG. 8B, the mouse pointer 850 is placed on top of the second element, and the second element is displayed in the rollover state 840, while the first, third, fourth and fifth elements are displayed in the normal state 860.

In some embodiments, a display is generated by the automated operation of file creation after author completion of the two step creation process (i.e., after author creation of a full screen graphics for each desired state, and after geometric identification of each interactive element). After author input of a full screen graphics for each state, and author definition (identification) of positional information for each interactive element, Carving Station automatically generates an image file for each state of each element. Accordingly, Carving Station automatically generates the multiple images, and records the respective positional information, once painstakingly created by the user through the “cutting and placing” process. For instance, in the FIGS. 5A and 5B example, for an interface having five two-state buttons, Carving Station will automatically generate the ten individual graphics (i.e., one graphic for each of five buttons for the normal state 510 and one graphic for each of five buttons for the rollover state 520) after author input of one full screen graphics for the normal state and one full screen graphics for the rollover state, and after author identification of the five interactive elements. So, as shown in FIG. 8B, when the mouse pointer 850 is placed on top of the second element, the present invention retrieves the automatically generated file for the second element in the rollover state 840 and accordingly displays that image in the second element location of the preview area 870.

In further embodiments of the present invention, such displays occur alternatively. For instance, rather than automatically generate and later retrieve the specific image for the rollover state 840 of the second element in the FIG. 8B example, the present invention could reference the full screen graphics created and stored for the rollover state, and present the respective portion thereof, as previously defined by the author for the second element, when the mouse pointer is placed on top of the second element, as in the FIG. 8B example. An additional alternative embodiment would have the full screen graphics for the normal state displayed in the preview area 870 (for instance, a look similar to that in FIG. 5B) and when the mouse pointer 850 is placed on top of the second element, as in the FIG. 8B example, the present invention essentially cuts out the second element, as previously positionally defined by the author, to reveal the full screen graphics for the rollover state, existing as an underlying layer. Since only the positional location of the second element has been removed, the only portion of the full screen graphics for the rollover state visible to the user is the second element portion.

Accordingly, Carving Station can greatly reduce the number of individual data points and graphic files that an author must supply and manage, eliminating the need for the author to manually define and reassemble each element layer to achieve the final interactive interface. Alteration and addition of elements using Carving Station does not require that the author repeat the “cutting and placing” steps, or repeat the defining and reassembly of each element layer in the interface.

### Tracking Embodiments

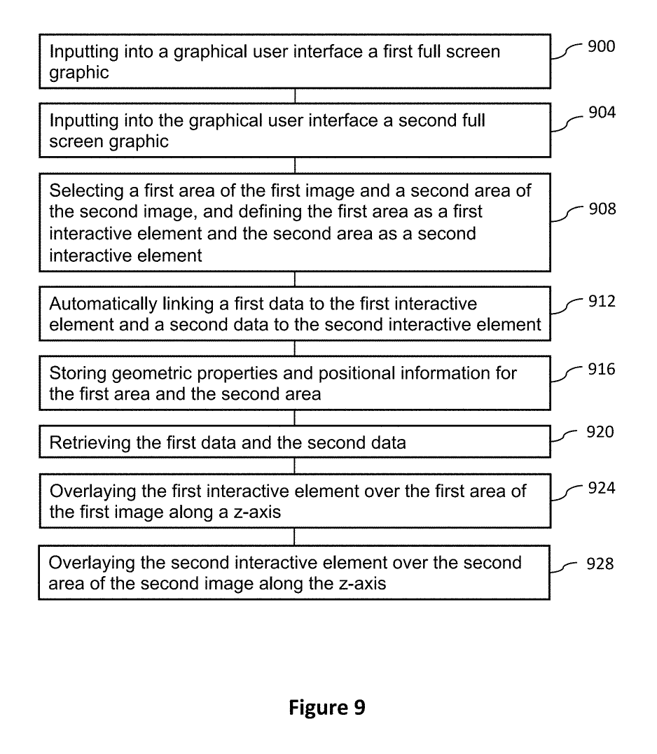

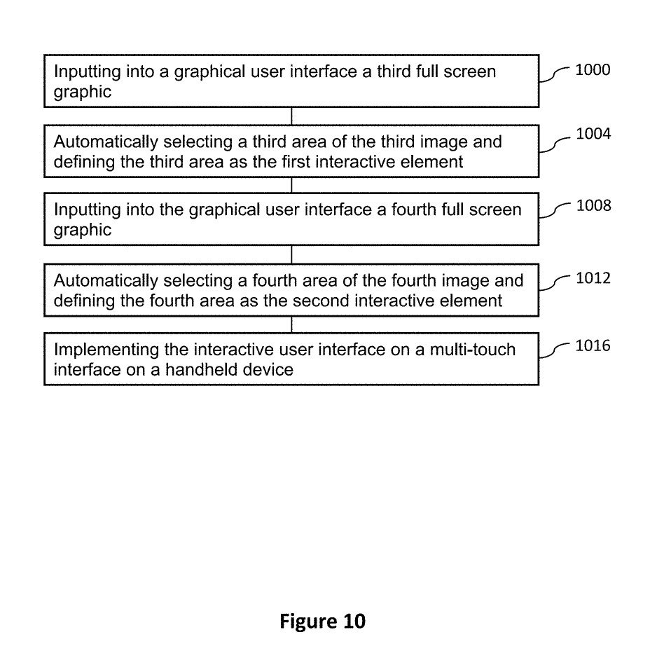

Embodiments of the present invention may include systems and methods that allow interactions with the application to be tracked and defined according to parameters as specified by the author. As shown in FIG. 9, methods may include inputting into a graphical user interface a first full screen graphic that includes a first image illustrating a graphic in a first state (at step 900) and inputting into the graphical user interface a second full screen graphic that includes a second image illustrating the graphic in a second state (at step 904). Methods may also include selecting a first area of the first image and a second area of the second image, and thereby defining the first area as a first interactive element and the second area as a second interactive element (at step 908). In order to track specific actions and interactions with the invention, methods may also include automatically linking a first data to the first interactive element and a second data to the second interactive element (at step 912).

Additionally, some embodiments may include storing geometric properties and positional information for the first area and the second area (at step 916). The first area of the first image can be located along an x-axis and a y-axis that is perpendicular to the x-axis. Additionally, the second area of the second image can also be located along the x-axis and the y-axis.

The first data can define information associated with the first interactive element and the second data can define information associated with the second interactive element. In order to track events and actions associated with each of the respective first and second interactive elements, the author of the system may recall the first and second data to interpret and decipher user interactions with the invention. Accordingly, methods may further include retrieving the first data and the second data (at step 920).

In some embodiments, the method includes overlaying the first interactive element over the first area of the first image along a z-axis that is perpendicular to both the x-axis and the y-axis (at step 924). As well, methods can include overlaying the second interactive element over the second area of the second image along the z-axis (at step 928).

Because the invention can reduce the number of steps required to change input graphics, the first data can be automatically linked with the first interactive element regardless of a graphic associated with the first interactive element. As well, the second data can be automatically linked with the second interactive element regardless of the graphic associated with the second interactive element.

Methods may also include inputting more than two full screen graphics, such as graphics that may be used to represent a third state, a fourth state, a fifth state, and the like. For example, methods include inputting into a graphical user interface a third full screen graphic that includes a third image illustrating a graphic in a third state (at step 1000). Accordingly, methods may include automatically selecting a third area of the third image and defining the third area as the first interactive element (at step 1004).

In some embodiments, the third area of the third image comprises identical geometric and positional data as the first area of the first image. As such, inputting into the graphical user interface the third full screen graphic can comprise automatically replacing the first full screen graphic with the third full screen graphic and automatically replacing the first area with the third area.

Methods may also include inputting into the graphical user interface a fourth full screen graphic that includes a fourth image illustrating the graphic in a fourth state (at step 1008). As well, methods may include automatically selecting a fourth area of the fourth image and defining the fourth area as the second interactive element (at step 1012). The fourth area of the fourth image can comprise identical geometric and positional data as the second area of the second image. Accordingly, inputting into the graphical user interface the fourth full screen graphic comprises automatically replacing the second full screen graphic with the fourth full screen graphic and automatically replacing the second area with the fourth area.

It should be appreciated that the interactive user interface can be implemented on a variety of devices. For example, in some embodiments, the interactive user interface can be implemented on a multi-touch interface on a handheld device (at step 1016), such as a smartphone, tablet, smart watch, and the like.

The tracking data can define any type of written or spoken language. In some embodiments, the tracking data defines English, Spanish, Chinese, Japanese, Portuguese, German, Russian, and the like.

### Data Input Embodiments

The disclosure also includes systems and methods directed towards data input embodiments including, but not limited to, creating, gathering data, and performing various events generally related to any type of interactive user interface, and more specifically related to any type of survey. Relating this back to previous sections of this disclosure, the systems and methods disclosed herein may allow developers to easily create interactive user interfaces by dragging and dropping an image(s) and then selecting one or more hot spots on the image. Developers may also predefine various events to occur when a user of the interface selects various hot spots, or inputs. In this regard, once the interactive user interface has been created, the system may perform various events based on input(s) received by the user. It should be appreciated that embodiments may include any of the features or components described throughout this disclosure. The systems and methods will now be further described by way of various example embodiments.

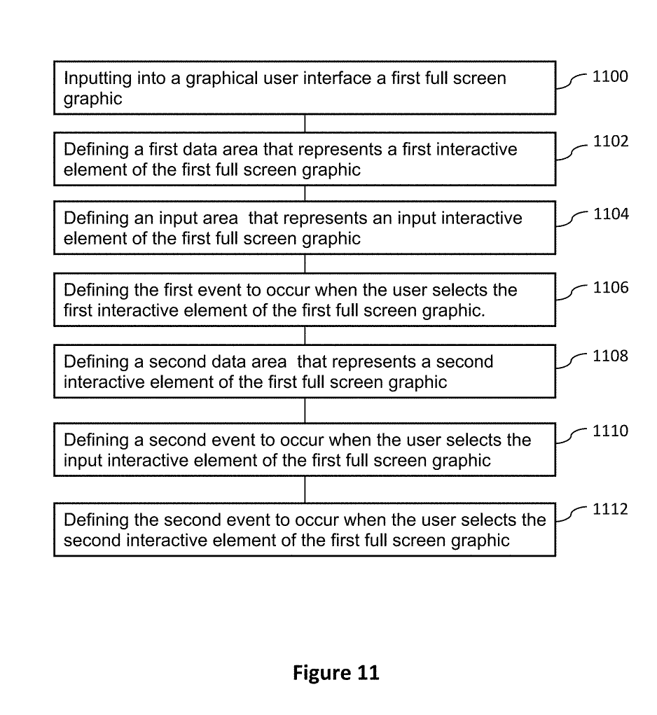

As shown in FIG. 11, some embodiments include inputting into a graphical user interface a first full screen graphic 1200 (at step 1100) and thereby defining a first data area 1202 that represents a first interactive element 1204, or hot spot, of the first full screen graphic 1200 (at step 1102). In some embodiments, the interactive element may be a survey input, a multiple-choice response to a question, an input requested from a user, and the like.

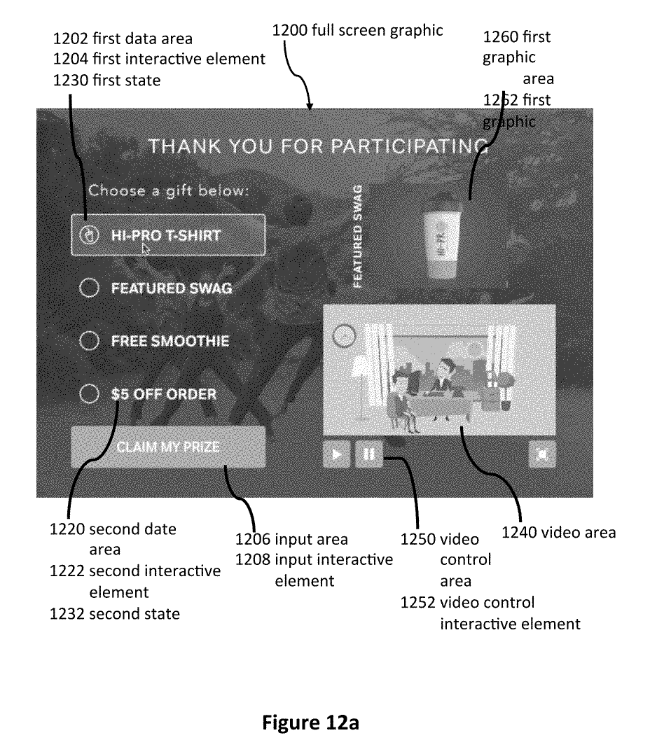

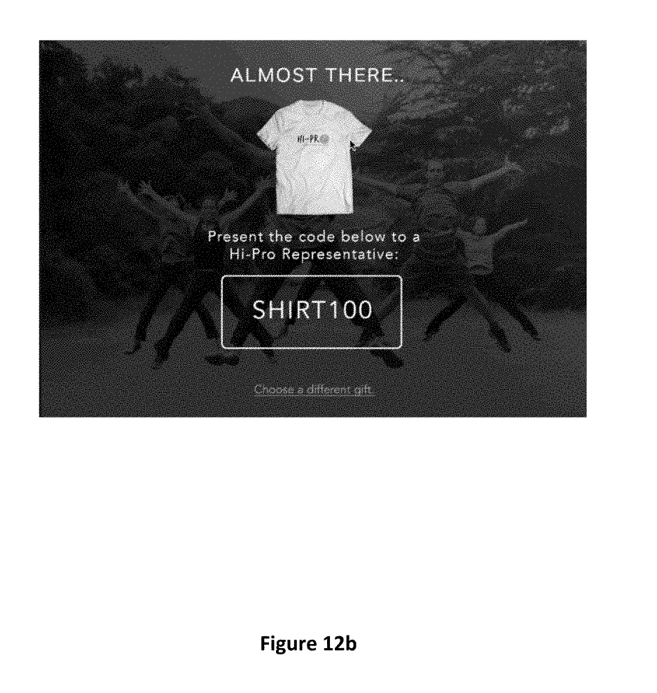

Additionally, systems and methods may include defining an input area 1206 that represents an input interactive element 1208 of the first full screen graphic 1200 (at step 1104). Embodiments may also include defining a first event to occur when a user selects either the first interactive element 1204 and/or the input interactive element 1208 of the first full screen graphic (at step 1106). In this regard, when a user clicks on the first interactive element 1204 and/or the input interactive element 1208, the system may perform the event (i.e. predefined action) based upon the interactive element selected. For example, as shown in FIG. 12a, the system may ask the user “Choose a gift below:” whereby the user selects “Hi-Pro T-Shirt” and then clicks “Claim my prize” to input the selection into the system. The system may then take the user to a different page, such as the one shown in FIG. 12b, which presents a code that the user may redeem to receive the selected prize. In some embodiments, the system and method does not require the user to select the input interactive element 1208 to perform the predefined event and performs the event when the user only selects the first interactive element 1204.

Because some of the embodiments disclosed herein include surveys and multiple-choice questions, systems and methods may also include defining additional inputs. Accordingly, embodiments may include defining a second data area 1220 that represents a second interactive element 1222 of the first full screen graphic (at step 1108). For example, as illustrated in FIG. 12a, the second interactive element 1222 may be any of the additional elements, such as “Featured Swag”, “Free Smoothie”, and/or “$5 off order”. Embodiments may also include defining a second event to occur when the user selects the input interactive element 1208 of the first full screen graphic (at step 1110). It should be appreciated that the second event may correspond to an event for the second interactive element 1222. Similar to the previous paragraph, embodiments may include defining the second event to occur when the user selects either the second interactive element 1222 and/or the input interactive element 1208 of the first full screen graphic 1200 (step 1112). It should be appreciated that the second event may be different from or the same as the first event. Moreover, because surveys and multiple choice questions may include two or more inputs or responses, systems and methods may include defining more than two inputs, such as, but not limited to, third, fourth, fifth, or more data areas that represent additional interactive elements.

The event(s) may include a plurality of actions, such as, but not limited to, navigating to a second full screen graphic, calculating a value, transmitting data to a remote computer, storing data, capturing a picture, and the like. Even still, in some embodiments, the event(s) may include calling the phone function, which may comprise dialing a phone number related to the hot spot, or calling a web browser and URL for a website. Event(s) may also include executing a web service request, such as calling an internet based computer program via an API, for data or processing, and/or making a request to an enterprise system (e.g. SAP system) to retrieve inventory data. Events may even include calling a mapping program to have it calculate directions, and/or calling an order entry system to place an order, and the like. Generally, it should be appreciated that the event may comprise any event associated with data input.

Furthermore, the interactive elements (i.e. survey inputs) may define various states, such as a first state 1230 and/or a second state 1232. For example, as shown in FIG. 12a, the first state 1230 may be a highlighted view of the interactive element, while the second state 1232 may be an un-highlighted view of the interactive element. Stated differently, the first state 1230 may define a first image and the second state 1232 may define a second image that is different from the first image. The states may also be referred to as normal state and/or down state.

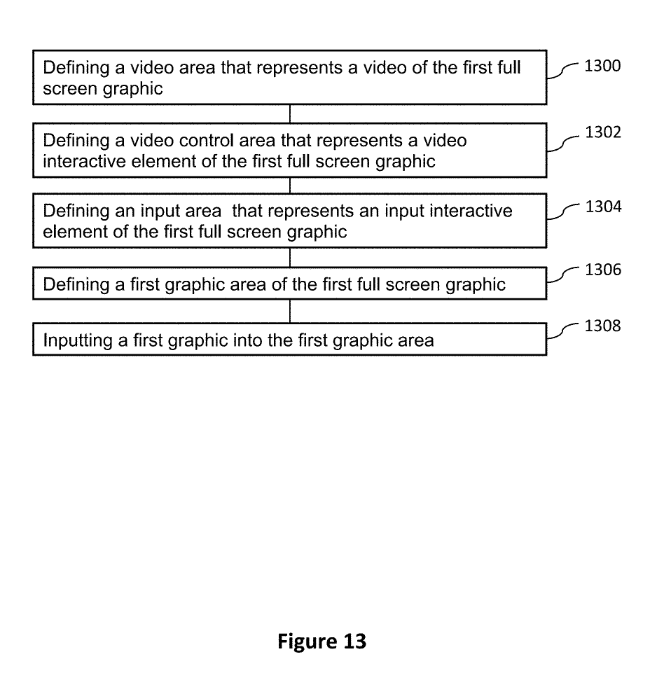

Now with reference to FIGS. 12a and 13, embodiments may also include defining supplementary areas and interactive elements, such as videos, and the like. For example, systems and methods may include defining a video area 1240 that represents a video (at step 1300). Embodiments may also include defining a video control area 1250 that represents at least one video control interactive element 1252 (at step 1302). The video control area 1250 may include controls, such as, but not limited to, a play button, a pause button, a full screen button, any type of control for a video, and the like. Accordingly, systems and methods may include defining a video event to occur when the user selects at least a portion of the video control interactive element 1252 (at step 1304). It should be appreciated that the video event may include at least one of play, pause, stop, enter a full screen mode of the video, replay video, jump to previous chapter, advance to next chapter, fast forward, rewind, volume up, volume down and the like.

The supplemental areas and interactive elements may also include images, pictures, and the like. Accordingly, embodiments may also include defining a first graphic area 1260 within the first full screen graphic 1200 (at step 1306). Accordingly, embodiments may include inputting a first graphic 1262 into the first graphic area 1260 (at step 1308). The first graphic 1262 may be smaller than the first full screen graphic 1200. As shown in FIG. 12a, the first graphic 1262 may include a graphic, such as the one shown in the upper right, which is the “Featured Swag” coffee cup image.

The systems and methods described herein may be implemented at least in part by one of a smartphone, a tablet, a computer, a remote server, a processor system, memory, any type of computing device, and the like. For example, in some embodiments, the devices and systems may include a processor system and memory coupled to the processor system. The memory may include executable instructions that, when executed by the processor system, cause the processor system to effectuate operations comprising any of the method steps within this disclosure.

### Interpretation

It should be appreciated that the phrase “Carving Station” can be used interchangeably with other terms, such as “Studio”. Generally, “Carving Station” and “Studio” are phrases and terms that can change as the industry and technology evolve.

None of the steps described herein is essential or indispensable. Any of the steps can be adjusted or modified. Other or additional steps can be used. Any portion of any of the steps, processes, structures, and/or devices disclosed or illustrated in one embodiment, flowchart, or example in this specification can be combined or used with or instead of any other portion of any of the steps, processes, structures, and/or devices disclosed or illustrated in a different embodiment, flowchart, or example. The embodiments and examples provided herein are not intended to be discrete and separate from each other.

The section headings and subheadings provided herein are nonlimiting. The section headings and subheadings do not represent or limit the full scope of the embodiments described in the sections to which the headings and subheadings pertain. For example, a section titled “Topic 1” may include embodiments that do not pertain to Topic 1 and embodiments described in other sections may apply to and be combined with embodiments described within the “Topic 1” section.

Some of the devices, systems, embodiments, and processes use computers. Each of the routines, processes, methods, and algorithms described in the preceding sections may be embodied in, and fully or partially automated by, code modules executed by one or more computers, computer processors, or machines configured to execute computer instructions. The code modules may be stored on any type of non-transitory computer-readable storage medium or tangible computer storage device, such as hard drives, solid state memory, flash memory, optical disc, and/or the like. The processes and algorithms may be implemented partially or wholly in application-specific circuitry. The results of the disclosed processes and process steps may be stored, persistently or otherwise, in any type of non-transitory computer storage such as, e.g., volatile or non-volatile storage.

The various features and processes described above may be used independently of one another, or may be combined in various ways. All possible combinations and subcombinations are intended to fall within the scope of this disclosure. In addition, certain method, event, state, or process blocks may be omitted in some implementations. The methods, steps, and processes described herein are also not limited to any particular sequence, and the blocks, steps, or states relating thereto can be performed in other sequences that are appropriate. For example, described tasks or events may be performed in an order other than the order specifically disclosed. Multiple steps may be combined in a single block or state. The example tasks or events may be performed in serial, in parallel, or in some other manner. Tasks or events may be added to or removed from the disclosed example embodiments. The example systems and components described herein may be configured differently than described. For example, elements may be added to, removed from, or rearranged compared to the disclosed example embodiments.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations and so forth. Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require at least one of X, at least one of Y, and at least one of Z to each be present.

The term “and/or” means that “and” applies to some embodiments and “or” applies to some embodiments. Thus, A, B, and/or C can be replaced with A, B, and C written in one sentence and A, B, or C written in another sentence. A, B, and/or C means that some embodiments can include A and B, some embodiments can include A and C, some embodiments can include B and C, some embodiments can only include A, some embodiments can include only B, some embodiments can include only C, and some embodiments include A, B, and C. The term “and/or” is used to avoid unnecessary redundancy.

While certain example embodiments have been described, these embodiments have been presented by way of example only, and are not intended to limit the scope of the inventions disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions, and changes in the form of the methods and systems described herein may be made without departing from the spirit of the inventions disclosed herein.

The following is claimed:

1. A method implemented at least in part by a machine for defining and generating graphics for one or more interactive elements to be used in an interactive user interface, the method comprising:
inputting into a graphical user interface a first full screen graphic;
defining a first data area that represents a first interactive element within the first full screen graphic;
defining an input area that represents an input interactive element within the first full screen graphic; and
defining a first event to occur when a user selects the input interactive element, wherein the first event corresponds to an event for the first interactive element.

2. The method of claim 1, further comprising defining the first event to occur when the user selects the first interactive element.

3. The method of claim 2, wherein the first event comprises at least one of navigating to a second full screen graphic, calculating a value, transmitting data to a remote computer, storing data, and capturing a picture.

4. The method of claim 2, wherein the first interactive element comprises a first state and a second state.

5. The method of claim 4, wherein the first state defines a first image and the second state defines a second image that is different from the first image.

6. The method of claim 5, wherein the first image comprises a non-highlighted image and the second image comprises a highlighted image.

7. The method of claim 2, further comprising:
defining a second data area that represents a second interactive element within the first full screen graphic; and
defining a second event to occur when the user selects the input interactive element, wherein the second event corresponds to an event for the second interactive element.

8. The method of claim 7, further comprising defining the second event to occur when the user selects the second interactive element.

9. The method of claim 8, wherein the second event is different from the first event.

10. The method of claim 1, further comprising:
defining a video area that represents a video within the first full screen graphic;
defining a video control area that represents a video control interactive element of the video; and
defining a video event to occur when the user selects at least a portion of the video control interactive element.

11. The method of claim 10, wherein the video event comprises at least one of playing, pausing, and entering a full screen mode of the video.

12. The method of claim 1, further comprising:
defining a first graphic area within the first full screen graphic; and
inputting a first graphic into the first graphic area, wherein the first graphic is smaller than the first full screen graphic.

13. The method of claim 1, wherein the method is implemented at least in part by one of a smartphone, a tablet, a computer, and a remote server.

14. A system for defining and generating graphics for one or more interactive elements to be used in an interactive user interface, the system comprising:
a processor system;
memory coupled to the processor system, the memory comprising executable instructions that, when executed by the processor system, cause the processor system to effectuate operations comprising:
inputting into a graphical user interface a first full screen graphic;
defining a first data area that represents a first interactive element within the first full screen graphic;
defining an input area that represents an input interactive element within the first full screen graphic; and
defining a first event to occur when a user selects the input interactive element, wherein the first event corresponds to an event for the first interactive element.

15. The system of claim 14, wherein the executable instructions further cause the processor system to effectuate operations comprising defining the first event to occur when the user selects the first interactive element.

16. The system of claim 15, wherein the first event comprises at least one of navigating to a second full screen graphic, calculating a value, transmitting data to a remote computer, storing data, and capturing a picture.

17. The system of claim 15, wherein the first interactive element comprises a first state defining a first image and a second state defining a second image.

18. The system of claim 15, wherein the executable instructions further cause the processor system to effectuate operations comprising:
defining a second data area that represents a second interactive element within the first full screen graphic;
defining a second event to occur when the user selects the input interactive element, wherein the second event corresponds to an event for the second interactive element; and
defining the second event to occur when the user selects the second interactive element.

19. The system of claim 14, wherein the executable instructions further cause the processor system to effectuate operations comprising:
defining a video area that represents a video;
defining a video control area that represents a video within the first full screen graphic; and
defining a video event to occur when the user selects at least a portion of the video control interactive element, wherein the video event comprises at least one of playing, pausing, and entering a full screen mode of the video.

20. The system of claim 14, wherein the executable instructions further cause the processor system to effectuate operations comprising:
defining a first graphic area within the first full screen graphic; and
inputting a first graphic into the first graphic area, wherein the first graphic is smaller than the first full screen graphic.
